(19) United States
(12) Patent Application Publication
(10) Pub. No.: US 2026/0150840 A1
(43) Pub. Date: Jun. 4, 2026

(54) ATTRACTANT FOR TELENOMUS REMUS NIXON TO CONTROL SPODOPTERA LITURA FABRICIUS, AND ACQUISITION METHOD THEREOF

(71) Applicants: YUNNAN TOBACCO CO., LTD. KUNMING BRANCH, Kunming (CN); INSTITUTE OF PLANT PROTECTION, CHINESE ACADEMY OF ARGICULTURAL SCIENCES, Beijing (CN)

(72) Inventors: Yonghui XIE, Kunming (CN); Zhengling LIU, Kunming (CN); Dekai NING, Kunming (CN); Hongming LI, Kunming (CN); Kebin LI, Kunming (CN); Jiao YIN, Kunming (CN); Gemei LIANG, Kunming (CN); Xiaofei GU, Kunming (CN); Zhimin WANG, Kunming (CN); Bu YI, Kunming (CN); Mingbo LI, Kunming (CN)

(73) Assignees: YUNNAN TOBACCO CO., LTD. KUNMING BRANCH, Kunming (CN); INSTITUTE OF PLANT PROTECTION, CHINESE ACADEMY OF AGRICULTURAL SCIENCES, Beijing (CN)

(21) Appl. No.: 18/978,046

(22) Filed: Dec. 12, 2024

(30) Foreign Application Priority Data
Nov. 29, 2024 (CN) 202411746530.0

(51) Int. Cl. A01N 43/78; A01N 27/00; A01N 29/04; A01P 19/00

(52) U.S. Cl. CPC A01N 43/78; A01N 27/00; A01N 29/04; A01P 19/00

(57) ABSTRACT

An attractant for Telenomus remus Nixon to control Spodoptera litura Fabricicus is provided. The attractant includes a solvent and at least one of the following components: 1,3-dichlorobenzene, benzothiazole, and octane. The attractant can effectively attract Telenomus remus Nixon to parasitize Spodoptera litura Fabricius eggs, such that the growth of a pest quantity is inhibited and the pest population gradually dies out, which achieves the purpose of pest control. The attractant is a green, non-toxic, and pollution-free attraction substance. Therefore, the attractant can solve a series of problems such as pesticide residues, environmental pollution, and food safety caused by chemical control, and is of great significance for the green control of Spodoptera litura Fabricius.

### CROSS REFERENCE TO THE RELATED APPLICATIONS

This application is based upon and claims priority to Chinese Patent Application No. 202411746530.0, filed on Nov. 29, 2024, the entire contents of which are incorporated herein by reference.

### TECHNICAL FIELD

The present disclosure relates to the technical field of biological control, and in particular to an attractant for Telenomus remus Nixon to control Spodoptera litura Fabricius, and an acquisition method thereof.

### BACKGROUND

Tobacco pests mainly include Spodoptera litura Fabricius, aphids, Helicoverpa assulta, Agrotis ipsilon, etc., which significantly affect the yield and quality of tobacco. Traditional pest control with chemical pesticides has a great impact on the quality of tobacco and causes heavy environmental pollution. In addition, the cost of traditional pest control with chemical pesticides is increasing. The biological control of tobacco pests is a scientific and effective method.

Spodoptera litura Fabricius belongs to the family Noctuidae in the order Lepidoptera and is one of the major pests for tobacco. For a long time, the control of Spodoptera litura Fabricius has mainly relied on chemical pesticides. With the long-term use of chemical pesticides in large quantities, the resistance of Spodoptera litura Fabricius to chemical pesticides gradually increases, and the control effect of chemical pesticides gradually decreases, resulting in problems such as pesticide residues, environmental pollution, and food safety. Therefore, biological control agents, such as fungi, bacteria, and parasitoid wasps, are urgently required to achieve the pollution-free and sustainable green control of Spodoptera litura Fabricius.

Telenomus remus Nixon belongs to the family Platygastridae in the order Hymenoptera and is an important parasitic natural enemy for various moth pests at the egg stage. Telenomus remus Nixon can effectively control Spodoptera litura Fabricius. This parasitoid wasp can efficiently parasitize the eggs of noctuid pests that are piled up in multiple layers and can exhibit a parasitism rate of 90% or more even for the innermost layer. In addition, this parasitoid wasp has advantages such as strong fecundity and easy colonization in the field. As a result, Telenomus remus Nixon is considered to be an important natural enemy insect resource for the biological control of noctuid pests and has a great application value. In order to improve the parasitic effect of Telenomus remus Nixon for Spodoptera litura Fabricius in tobacco, an attractant with a prominent attracting effect for Telenomus remus Nixon is urgently needed in the prior art.

### SUMMARY

The technical problem solved by the present disclosure is to provide an attractant for Telenomus remus Nixon to control Spodoptera litura Fabricius, and an acquisition method thereof.

Specific technical solutions are as follows:
An attractant for Telenomus remus Nixon to control Spodoptera litura Fabricius is provided, including a solvent and at least one of the following components: 1,3-dichlorobenzene, benzothiazole, and octane.

Preferably, the attractant includes the solvent and the 1,3-dichlorobenzene, and a concentration of the 1,3-dichlorobenzene is 1 μg/μL.

Preferably, the attractant includes the solvent and the benzothiazole, and a concentration of the benzothiazole is 1 μg/μL.

Preferably, the attractant includes the solvent and the octane, and a concentration of the octane is 1 μg/μL.

Preferably, the attractant includes the solvent, the 1,3-dichlorobenzene, and the benzothiazole, and concentrations of the 1,3-dichlorobenzene and the benzothiazole both are 1μg/μL.

Preferably, the attractant includes the solvent, the benzothiazole, and the octane, and concentrations of the benzothiazole and the octane both are 1 μg/μL.

Preferably, the attractant includes the solvent, the 1,3-dichlorobenzene, and the octane, and concentrations of the 1,3-dichlorobenzene and the octane both are 1 μg/μL.

Preferably, the solvent is n-hexane.

The present disclosure also provides a method for acquiring the attractant for Telenomus remus Nixon to control Spodoptera litura Fabricius, including:
step 1, providing tobacco leaves and Spodoptera litura Fabricius eggs, arranging the Spodoptera litura Fabricius eggs on the tobacco leaves, and collecting and extracting volatiles of the tobacco leaves and the Spodoptera litura Fabricius eggs with an atmospheric sampling instrument by a dynamic headspace technique;
step 2, identification of the volatiles of the tobacco leaves and the Spodoptera litura Fabricius eggs: analyzing the volatiles by gas chromatography-mass spectrometry to determine a composition of the volatiles; and
step 3, determination of behavioral responses: conducting a Y-type olfactometer test for the volatiles of the tobacco leaves and the Spodoptera litura Fabricius eggs, and determining the behavioral responses of Telenomus remus Nixon adults to the volatiles to acquire the attractant.

Preferably, in the step 1, leaves of a healthy tobacco plant that suffers from no pests or diseases and grows vigorously are selected as the tobacco leaves.

The attractant for Telenomus remus Nixon to control Spodoptera litura Fabricius and the acquisition method thereof provided by the present disclosure have the following technical effects:
The attractant provided by the present disclosure can enhance a parasitic effect of Telenomus remus Nixon in Spodoptera litura Fabricius for tobacco. Moreover, a concentration of the attractant affects an attraction effect of the attractant. The inventors have found that the concentration of the attractant is not linearly correlated with the attraction effect of the attractant, and have determined the optimal concentration to allow the optimal attraction effect. The attractant of the present disclosure can effectively attract Telenomus remus Nixon to parasitize Spodoptera litura Fabricius eggs, such that the growth of a pest quantity is inhibited and the pest population gradually dies out, which achieves the purpose of pest control. The attractant of the present disclosure is a green, non-toxic, and pollution-free attraction substance. Therefore, the present disclosure can solve a series of problems such as pesticide residues, environmental pollution, and food safety caused by chemical control, and is of great significance for the green control of Spodoptera litura Fabricius.

The n-hexane is adopted as a solvent due to the following factors: 1. Parasitoid wasps exhibit specified tropism to n-hexane. Thus, the experimental results with n-hexane as a control are convincing. 2. When a volatile crude extract is collected and cleaned, in order to completely elute all compounds, the n-hexane enabling easy elution is selected because other solvents such as paraffin oil cannot allow complete elution.

In the step 1, leaves of a healthy tobacco plant that suffers from no pests or diseases and grows vigorously are selected as the tobacco leaves because other factors must be excluded as much as possible in the determination of a volatile of the tobacco leaves.

### BRIEF DESCRIPTION OF THE DRAWINGS

FIG. 1 is a schematic diagram of comparison of attraction effects of 1,3-dichlorobenzene, benzothiazole, octane, and corresponding control group experiments for Telenomus remus Nixon adults;

FIG. 2 is a schematic diagram of comparison of attraction effects of different concentrations of 1,3-dichlorobenzene and corresponding control group experiments for Telenomus remus Nixon adults;

FIG. 3 is a schematic diagram of comparison of attraction effects of different concentrations of benzothiazole and corresponding control group experiments for Telenomus remus Nixon adults;

FIG. 4 is a schematic diagram of comparison of attraction effects of different concentrations of octane and corresponding control group experiments for Telenomus remus Nixon adults; and

FIG. 5 shows attraction effects of 1,3-dichlorobenzene+benzothiazole, 1,3-dichlorobenzene+octane, and benzothiazole+octane compositions and corresponding control group experiments for Telenomus remus Nixon adults.

### DETAILED DESCRIPTION OF THE EMBODIMENTS

The present disclosure is further described below with reference to the accompanying drawings and implementations.

The present disclosure provides an attractant for Telenomus remus Nixon to control Spodoptera litura Fabricius, including a solvent and at least one of the following components: 1,3-dichlorobenzene, benzothiazole, and octane.

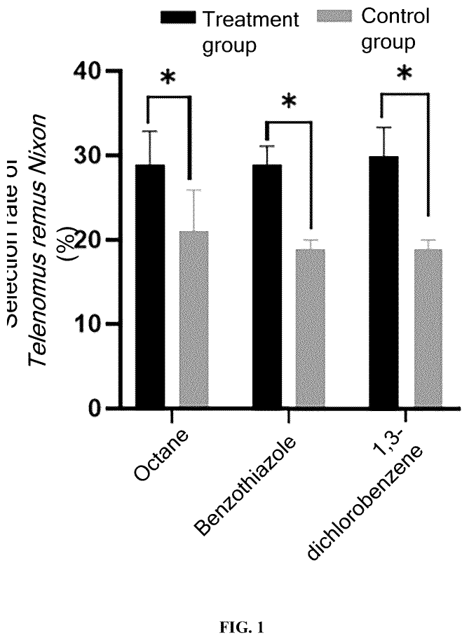

For the component 1,3-dichlorobenzene, the following contrast experiment was conducted:
A Y-tube was provided. A treatment group (a mixture of the 1,3-dichlorobenzene and the solvent) was added to one branch of the Y-tube, and a control group (the solvent) was added to the other branch of the Y-tube. A plurality of Telenomus remus Nixon wasps were placed in a main tube of the Y-tube that communicated with the two branches. After a specified period of time, selection rates of the Telenomus remus Nixon wasps for the treatment group and the control group could be generated, and results were shown in FIG. 1.

For the component benzothiazole, the following contrast experiment was conducted:
A Y-tube was provided. A treatment group (a mixture of the benzothiazole and the solvent) was added to one branch of the Y-tube, and a control group (the solvent) was added to the other branch of the Y-tube. A plurality of Telenomus remus Nixon wasps were placed in a main tube of the Y-tube that communicated with the two branches. After a specified period of time, selection rates of the Telenomus remus Nixon wasps for the treatment group and the control group could be generated, and results were shown in FIG. 1.

For the component octane, the following contrast experiment was conducted:
A Y-tube was provided. A treatment group (a mixture of the octane and the solvent) was added to one branch of the Y-tube, and a control group (the solvent) was added to the other branch of the Y-tube. A plurality of Telenomus remus Nixon wasps were placed in a main tube of the Y-tube that communicated with the two branches. After a specified period of time, selection rates of the Telenomus remus Nixon wasps for the treatment group and the control group could be generated, and results were shown in FIG. 1.

It can be intuitively seen from FIG. 1 that any of the 1,3-dichlorobenzene, the benzothiazole, and the octane has a prominent attraction effect.

Further, the attractant includes the solvent and the 1,3-dichlorobenzene, and a concentration of the 1,3-dichlorobenzene is 1 μg/μL.

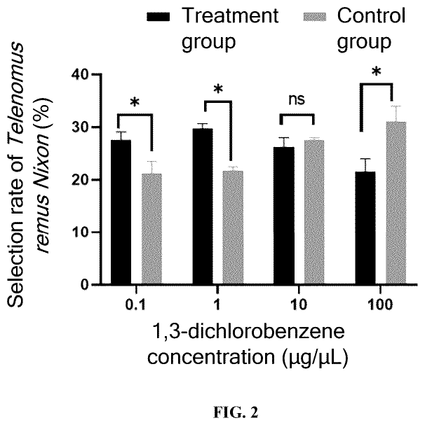

For the component 1,3-dichlorobenzene, four treatment groups with concentrations of 0.1 μg/μL, 1 μg/μL, 10 μg/μL, and 100 μg/μL respectively were provided, and the following four contrast experiments were conducted:
(1) A Y-tube was provided. A treatment group (a mixture of the 1,3-dichlorobenzene and the solvent, where a concentration of the 1,3-dichlorobenzene was 0.1 μg/μL) was added to one branch of the Y-tube, and a control group (the solvent) was added to the other branch of the Y-tube. A plurality of Telenomus remus Nixon wasps were placed in a main tube of the Y-tube that communicated with the two branches. After a specified period of time, selection rates of the Telenomus remus Nixon wasps for the treatment group and the control group could be generated, and results were shown in FIG. 2.
(2) A Y-tube was provided. A treatment group (a mixture of the 1,3-dichlorobenzene and the solvent, where a concentration of the 1,3-dichlorobenzene was 1 μg/μL) was added to one branch of the Y-tube, and a control group (the solvent) was added to the other branch of the Y-tube. A plurality of Telenomus remus Nixon wasps were placed in a main tube of the Y-tube that communicated with the two branches. After a specified period of time, selection rates of the Telenomus remus Nixon wasps for the treatment group and the control group could be generated, and results were shown in FIG. 2.
(3) A Y-tube was provided. A treatment group (a mixture of the 1,3-dichlorobenzene and the solvent, where a concentration of the 1,3-dichlorobenzene was 10 μg/μL) was added to one branch of the Y-tube, and a control group (the solvent) was added to the other branch of the Y-tube. A plurality of Telenomus remus Nixon wasps were placed in a main tube of the Y-tube that communicated with the two branches. After a specified period of time, selection rates of the Telenomus remus Nixon wasps for the treatment group and the control group could be generated, and results were shown in FIG. 2.
(4) A Y-tube was provided. A treatment group (a mixture of the 1,3-dichlorobenzene and the solvent, where a concentration of the 1,3-dichlorobenzene was 100 μg/μL) was added to one branch of the Y-tube, and a control group (the solvent) was added to the other branch of the Y-tube. A plurality of Telenomus remus Nixon wasps were placed in a main tube of the Y-tube that communicated with the two branches. After a specified period of time, selection rates of the Telenomus remus Nixon wasps for the treatment group and the control group could be generated, and results were shown in FIG. 2.

It can be seen that the 1,3-dichlorobenzene at a concentration of 1 μg/μL exhibits the optimal attraction effect.

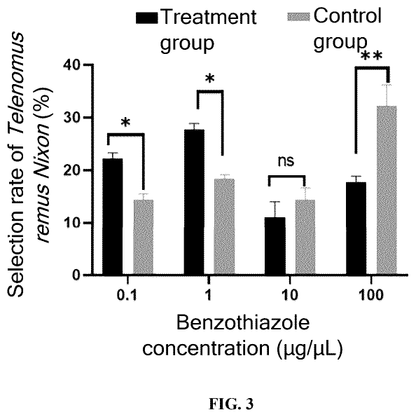

Similarly, for the component benzothiazole, four treatment groups with concentrations of 0.1 μg/μL, 1 μg/μL, 10 μg/μL, and 100 μg/μL respectively were provided, and four contrast experiments were conducted. A specific process was the same as above, and results were shown in FIG. 3.

When the attractant includes the solvent and the benzothiazole, a benzothiazole concentration of 1 μg/μL allows the optimal attraction effect.

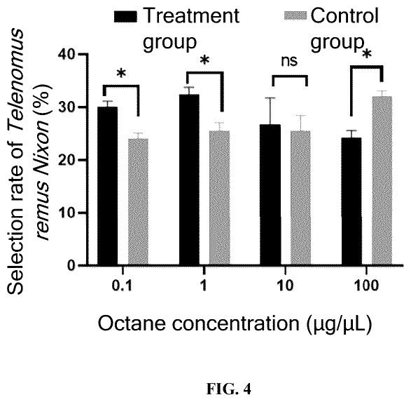

Similarly, for the component octane, four treatment groups with concentrations of 0.1 μg/μL, 1 μg/μL, 10 μg/μL, and 100 μg/μL respectively were provided, and four contrast experiments were conducted. A specific process was the same as above, and results were shown in FIG. 4.

When the attractant includes the solvent and the octane, an octane concentration of 1 μg/μL allows the optimal attraction effect.

Further, the attractant includes the solvent, the 1,3-dichlorobenzene, and the benzothiazole, and concentrations of the 1,3-dichlorobenzene and the benzothiazole both are 1 μg/μL. Or

The attractant includes the solvent, the benzothiazole, and the octane, and concentrations of the benzothiazole and the octane both are 1 μg/μL. Or

The attractant includes the solvent, the 1,3-dichlorobenzene, and the octane, and concentrations of the 1,3-dichlorobenzene and the octane both are 1 μg/μL.

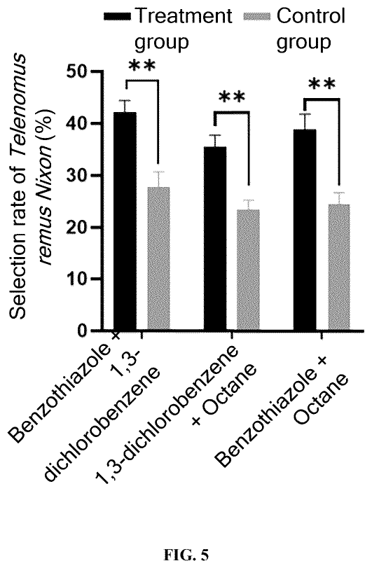

As shown in FIG. 5, the contrast experiment with a Y-tube mentioned above was conducted for these combinations and the corresponding concentration limitations. In the consideration of a cost and other conditions, these combinations and the corresponding concentration limitations can achieve prominent attraction effects. For example, for “the attractant including the solvent, the 1,3-dichlorobenzene, and the benzothiazole”, the following experimental process was conducted:
A Y-tube was provided. A treatment group (a mixture of the solvent, the 1,3-dichlorobenzene, and the benzothiazole, where concentrations of the 1,3-dichlorobenzene and the benzothiazole both were 1 μg/μL) was added to one branch of the Y-tube, and a control group (the solvent) was added to the other branch of the Y-tube. A plurality of Telenomus remus Nixon wasps were placed in a main tube of the Y-tube that communicated with the two branches. After a specified period of time, selection rates of the Telenomus remus Nixon wasps for the treatment group and the control group could be generated, and results were shown in FIG. 5.

Similarly, for each of “the attractant including the solvent, the benzothiazole, and the octane” and “the attractant including the solvent, the 1,3-dichlorobenzene, and the octane”, the above experiment was conducted. Results were shown in FIG. 5.

Further, the solvent is n-hexane. The n-hexane is adopted as a solvent due to the following factors: 1. Parasitoid wasps exhibit specified tropism to n-hexane. Thus, the experimental results with n-hexane as a control are convincing. 2. When a volatile crude extract is collected and cleaned, in order to completely elute all compounds, the n-hexane enabling easy elution is selected because other solvents such as paraffin oil cannot allow complete elution.

The present disclosure also provides a method for acquiring the attractant for Telenomus remus Nixon to control Spodoptera litura Fabricius, including:
Step 1: Tobacco leaves and Spodoptera litura Fabricius eggs were provided, the Spodoptera litura Fabricius eggs were arranged on the tobacco leaves, and volatiles of the tobacco leaves and the Spodoptera litura Fabricius eggs were collected and extracted with an atmospheric sampling instrument by a dynamic headspace technique.
Step 2: Identification of the volatiles of the tobacco leaves and the Spodoptera litura Fabricius eggs: The volatiles were analyzed by gas chromatography-mass spectrometry to determine a composition of the volatiles.
Step 3: Determination of behavioral responses: A Y-type olfactometer test was conducted for the volatiles of the tobacco leaves and the Spodoptera litura Fabricius eggs, and the behavioral responses of Telenomus remus Nixon adults to the volatiles were determined to acquire the attractant.

In the step 1, leaves of a healthy tobacco plant that suffers from no pests or diseases and grows vigorously were selected as the tobacco leaves because other factors must be excluded as much as possible in the determination of a volatile of the tobacco leaves.

The above are merely embodiments of the present disclosure and do not limit the patent scope of the present disclosure. Any equivalent structure or equivalent process change made with the description and the accompanying drawings of the present disclosure, or direct or indirect application thereof in other related technical fields, shall still fall in the protection scope of the patent of the present disclosure.

What is claimed is:

1. An attractant for Telenomus remus Nixon to control Spodoptera litura Fabricius, comprising a solvent and at least one of the following components: 1,3-dichlorobenzene, benzothiazole, and octane.

2. The attractant for the Telenomus remus Nixon to control the Spodoptera litura Fabricius according to claim 1, wherein the attractant comprises the solvent and the 1,3-dichlorobenzene, and a concentration of the 1,3-dichlorobenzene is 1 μg/μL.

3. The attractant for the Telenomus remus Nixon to control the Spodoptera litura Fabricius according to claim 1, wherein the attractant comprises the solvent and the benzothiazole, and a concentration of the benzothiazole is 1 μg/μL.

4. The attractant for the Telenomus remus Nixon to control the Spodoptera litura Fabricius according to claim 1, wherein the attractant comprises the solvent and the octane, and a concentration of the octane is 1 μg/μL.

5. The attractant for the Telenomus remus Nixon to control theSpodoptera litura Fabricius according to claim 1, wherein the attractant comprises the solvent, the 1,3-dichlorobenzene, and the benzothiazole, and concentrations of the 1,3-dichlorobenzene and the benzothiazole both are 1 μg/μL.

6. The attractant for the Telenomus remus Nixon to control the Spodoptera litura Fabricius according to claim 1, wherein the attractant comprises the solvent, the benzothiazole, and the octane, and concentrations of the benzothiazole and the octane both are 1 μg/μL.

7. The attractant for the Telenomus remus Nixon to control the Spodoptera litura Fabricius according to claim 1, wherein the attractant comprises the solvent, the 1,3-dichlorobenzene, and the octane, and concentrations of the 1,3-dichlorobenzene and the octane both are 1 μg/μL.

8. The attractant for the Telenomus remus Nixon to control the Spodoptera litura Fabricius according to claim 1, wherein the solvent is n-hexane.

9. A method for acquiring the attractant for the Telenomus remus Nixon to control the Spodoptera litura Fabricius according to claim 1, comprising:
step 1, providing tobacco leaves and Spodoptera litura Fabricius eggs, arranging the Spodoptera litura Fabricius eggs on the tobacco leaves, and collecting and extracting volatiles of the tobacco leaves and the Spodoptera litura Fabricius eggs with an atmospheric sampling instrument by a dynamic headspace technique;
step 2, an identification of the volatiles: analyzing the volatiles by gas chromatography-mass spectrometry to determine a composition of the volatiles; and
step 3, a determination of behavioral responses: conducting a Y-type olfactometer test for the volatiles, and determining the behavioral responses of Telenomus remus Nixon adults to the volatiles to acquire the attractant.

10. The method according to claim 9, wherein in the step 1, leaves of a healthy tobacco plant with no pests or diseases and vigorous growth are selected as the tobacco leaves.

11. The attractant for the Telenomus remus Nixon to control the Spodoptera litura Fabricius according to claim 2, wherein the solvent is n-hexane.

12. The attractant for the Telenomus remus Nixon to control the Spodoptera litura Fabricius according to claim 3, wherein the solvent is n-hexane.

13. The attractant for the Telenomus remus Nixon to control the Spodoptera litura Fabricius according to claim 4, wherein the solvent is n-hexane.

14. The attractant for the Telenomus remus Nixon to control the Spodoptera litura Fabricius according to claim 5, wherein the solvent is n-hexane.

15. The attractant for the Telenomus remus Nixon to control the Spodoptera litura Fabricius according to claim 6, wherein the solvent is n-hexane.

16. The attractant for the Telenomus remus Nixon to control the Spodoptera litura Fabricius according to claim 7, wherein the solvent is n-hexane.

17. The method according to claim 9, wherein the attractant comprises the solvent and the 1,3-dichlorobenzene, and a concentration of the 1,3-dichlorobenzene is 1 μg/μL.

18. The method according to claim 9, wherein the attractant comprises the solvent and the benzothiazole, and a concentration of the benzothiazole is 1 μg/μL.

19. The method according to claim 9, wherein the attractant comprises the solvent and the octane, and a concentration of the octane is 1 μg/μL.

20. The method according to claim 9, wherein the attractant comprises the solvent, the 1,3-dichlorobenzene, and the benzothiazole, and concentrations of the 1,3-dichlorobenzene and the benzothiazole both are 1 μg/μL.
